(19) United States
(12) Patent Application Publication
(10) Pub. No.: US 2009/0138106 A1
(43) Pub. Date: May 28, 2009

(54) CONTROL DEVICE, MACHINE TOOL, AND DISPLAYING METHOD

(75) Inventors: YOSHIMI KOMATSU, Gotemba-Shi (JP); Masato Tominaga, Kannami-Cho (JP)

Correspondence Address: DLA PIPER LLP US, P. O. BOX 2758, RESTON, VA, 20195, US

(73) Assignee: TOSHIBA KIKAI KABUSHIKI KAISHA, Chiyoda-Ku (JP)

(21) Appl. No.: 12/276,437

(22) Filed: Nov. 24, 2008

(30) Foreign Application Priority Data
Nov. 26, 2007 (JP) 2007-304087

(51) Int. Cl. G05B 9/02

(52) U.S. Cl. 700/79

(57) ABSTRACT

A numerical control device includes a display, a memory, and a CPU (central processing unit). The display displays an image based on image information stored in a video memory. The memory stores internal information used when a failure occurs in the numerical control device. The CPU includes a code creator and a display controller. The code creator creates a matrix two-dimensional code of the internal information stored in the memory. The display controller synthesizes image information stored in the video memory with a matrix two-dimensional code created in the code creator to display the matrix two-dimensional code on the display.

### BACKGROUND OF THE INVENTION

1. Field of the Invention

The present invention relates to a control device, a machine tool, and a displaying method.

2. Description of Related Art

Conventionally, a control device such as a numerical control device that has a display and controls operation of a machine tool via numerical information and a servo mechanism has been known (see, e.g., Document 1: JP-A-3-78005).

When a failure occurs in such a control device, it is required to output information regarding an internal status of the device such as a version and a revision of software for operating the control device and statuses of internal memory and I/O (Input/Output) (hereinafter referred to as internal information) and send the outputted internal information to a manufacturer of the control device.

A numerical control device disclosed in Document 1 has a communication control circuit to utilize network communications via a modem to output the internal information and transfer the internal information to the manufacturer.

However, because the numerical control device disclosed in Document 1 needs to be provided with a communication control circuit for utilizing the network communications, the control device is enlarged and manufacturing cost is increased.

On the other hand, it may be worthwhile to discuss a method in which the internal information is recorded on a recording medium such as a flexible disc as a way of being outputted and sent to the manufacturer. However, because such a method also requires a disc drive or the like to be provided to the control device for reading and writing on the recording medium, the control device is enlarged and the manufacturing cost is elevated. In addition, control of the recording medium is a time-consuming effort.

With regards to a control device that cannot record internal information on a recording medium and a control device that cannot utilize network communications, there is another method, in which an operator takes notes of internal information displayed on a display as a way of outputting the internal information.

However, such an output method is time-consuming for the operator, and incorrect output of the internal information may be made because of mistakes in taking notes.

### SUMMARY OF THE INVENTION

An object of the invention is to provide a control device, a machine tool, and a displaying method capable of easily and reliably outputting internal information.

A control device according to an aspect of the invention is a control device having a display, the control device including: a storage that stores information used when a failure occurs in the control device; a code creator that creates an optical code of the information stored in the storage; and a display controller that displays the optical code on the display.

Here, the optical code may exemplarily be a one-dimensional code (bar code), a stack two-dimensional code, or a matrix two-dimensional code. Incidentally, the matrix two-dimensional code may exemplarily be QR code (registered trademark).

With this aspect of the invention, the display controller can display the optical code of the internal information created in the code creator on the display. Accordingly, the operator can use a portable terminal or the like capable of reading an optical code to output the internal information coded in the optical code. As a result, the operator can easily and reliably output the internal information to send the outputted internal information to a manufacturer of the control device via network communications or the like.

Incidentally, the portable terminal capable of reading the optical code exemplarily may be a mobile phone capable of reading a matrix two-dimensional code. A mobile phone typically has an electronic mail function, a network communication function and the like, so that the outputted internal information can be easily sent to the manufacturer.

According to the aspect of the invention, it is not necessary to provide a disc drive for reading and writing on a recording medium or an apparatus for utilizing network communications, so that the control device can be downsized and the manufacturing cost can be reduced. In addition, a time-consuming effort of controlling the recording medium can be omitted.

Further, since it is not necessary for the operator to take notes of internal information displayed on the display, incorrect output of the internal information due to mistakes in cumbersome note-taking does not occur.

In the above arrangement, it is preferable that the optical code is a two-dimensional code.

With this arrangement, more internal information can be outputted than in the case where a one-dimensional code is employed as the optical code.

A machine tool according to an aspect of the invention is controlled by the above-described control device.

With this arrangement, the machine tool can attain the same advantages as the above-mentioned control device.

A displaying method according to another aspect of the invention is a displaying method employed for a control device including a display, the displaying method including: executing a code creating step that creates an optical code of information used when a failure occurs in the control device; and executing a display controlling step that displays the optical code on the display.

With this method, the same advantages as the above-mentioned control device can be attained.

### BRIEF DESCRIPTION OF THE DRAWINGS

FIG. 1 is a block diagram showing a schematic arrangement of a numerical control device and a machine tool according to an embodiment of the invention.

FIG. 2 is a flowchart showing a display control process for internal information in the embodiment.

### DETAILED DESCRIPTION OF PREFERRED EMBODIMENT(S)

An embodiment of the invention will be described below with reference to the drawings.

### Schematic Arrangement of Numerical Control Device

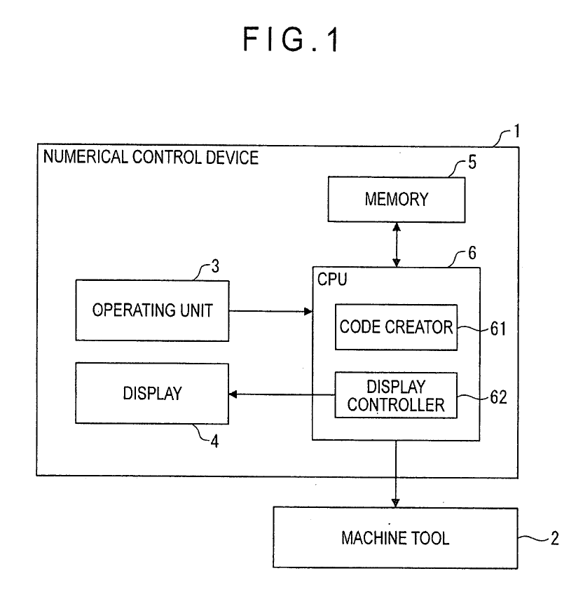

FIG. 1 is a block diagram showing a schematic arrangement of a numerical control device 1 and a machine tool 2.

The numerical control device 1 (control device) controls operation of the machine tool 2 via numerical information and a servo mechanism, and includes an operating unit 3, a display 4, a memory 5, and a CPU (central processing unit) 6 as shown in FIG. 1.

The operating unit 3, which outputs operational signals based on the operation by an operator who utilizes the numerical control device 1, may exemplarily be an operating panel exposed to an outside of the numerical control device 1.

The display 4, which displays images based on image information stored in video memory (not shown) provided within the numerical control device 1, may exemplarily be an LCD (liquid crystal display) panel.

The memory 5 (storage) stores internal information used when a failure occurs in the numerical control device 1. Incidentally, the memory 5 stores a version, a revision or the like of software for operating the numerical control device 1 as internal information in the embodiment.

The CPU 6 controls the entire numerical control device 1. For example, based on an inputted program, the CPU 6 controls operation of the servo motor (not shown) to control the machine tool 2. Incidentally, among processes in the CPU 6, only a display control process (described below) for the internal information is mainly described, and description of other processes will be omitted in the embodiment.

The CPU 6 includes a code creator 61 and a display controller 62.

The code creator 61 creates a matrix two-dimensional code (optical code) of the internal information stored in the memory 5.

The display controller 62 synthesizes image information stored in the video memory with a matrix two-dimensional code created in the code creator 61 to display the matrix two-dimensional code on the display 4. Incidentally, the display 4 has a resolution adapted to display the matrix two-dimensional code created in the code creator 61. For example, when QR code is employed as the matrix two-dimensional code, the display 4 at least has a resolution adapted to display QR code including the smallest information, which is type 1 in the numbered types of symbols of QR code.

### Display Control Process for Internal Information

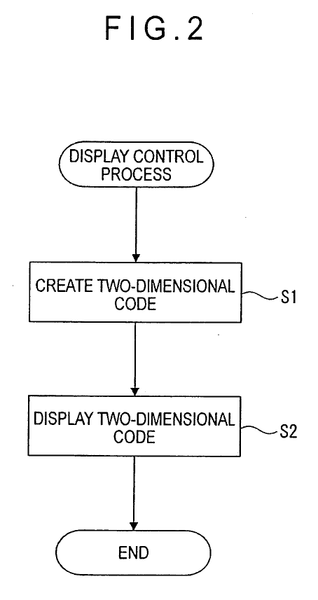

Next, a display control process of internal information by the numerical control device 1 will be described with reference to FIG. 2.

FIG. 2 is a flowchart showing a display control process for internal information.

When an operator using the numerical control device 1 carries out a manipulation for displaying predetermined internal information (e.g., a version of software) via the operating unit 3, the numerical control device 1 executes the display control process for the internal information, as shown in FIG. 2.

Initially, the operating unit 3 outputs an operational signal based on the manipulation by the operator to the CPU 6. When the operational signal is inputted, the code creator 61 creates a matrix two-dimensional code of the predetermined internal information based on the inputted operational signal (Step S1: code creating step). Incidentally, if the amount of the internal information is too large to be contained in one matrix two-dimensional code, the code creator 61 divides the internal information into a plurality of groups to create a plurality of matrix two-dimensional codes.

After the two dimensional code is created in the code creator 61, the display controller 62 synthesizes image information stored in the video memory with the matrix two-dimensional code created in the code creator 61 (Step S2: display control step).

Then, after the matrix two-dimensional code is synthesized, the display 4 displays the matrix two-dimensional code by displaying the image information stored in the video memory.

Incidentally, if a plurality of matrix two-dimensional codes are created in the code creator 61, the operator can switch, by manipulating the operating unit 3, the matrix two-dimensional codes displayed on the display 4.

The following advantages are attained with the numerical control device 1 according to the embodiment.

(1) The display controller 62 can display the matrix two-dimensional code of the internal information created in the code creator 61 on the display 4. With this arrangement, the operator can use a portable terminal or the like capable of reading a matrix two-dimensional code to output the internal information coded in the matrix two-dimensional code. Accordingly, the operator can easily and reliably output the internal information to send the outputted internal information to a manufacturer of the numerical control device 1 via network communications or the like.

(2) Since the code creator 61 creates a matrix two-dimensional code for the internal information stored in the memory 5, more internal information can be outputted than in the case where a one-dimensional code is created.

(3) When the amount of the internal information is too large to be contained in one matrix two-dimensional code, the operator can switch the matrix two-dimensional codes displayed on the display 4 by manipulating the operating unit 3. Accordingly, the operator can easily and reliably output a large amount of internal information to sequentially send the outputted internal information to the manufacturer of the numerical control device 1.

### Modifications of Embodiment

Note that the scope of the invention is not limited to the above embodiment, but includes modifications, improvements and the like as long as an object of the invention can be achieved.

A matrix two-dimensional code is employed as the optical code in the embodiment, but the optical code may be, for example, a stack two-dimensional code or a one-dimensional code. In other words, it is only required that the code creator creates an optical code for internal information.

The machine tool 2 is controlled by the numerical control device 1 in the embodiment, but any suitable control device may be employed for the invention. Incidentally, examples of the control device include a control device of an injection molding machine and a control device of an industrial machine such as a die casting machine.

The priority application Number JP2007-304087 upon which this patent application is based is hereby incorporated by reference.

What is claimed is:

1. A control device including a display, the control device comprising:
a storage that stores information used when a failure occurs in the control device;
a code creator that creates an optical code of the information stored in the storage; and
a display controller that displays the optical code on the display.

2. A control device according to claim 1, wherein
the optical code is a two-dimensional code.

3. A machine tool that is controlled by the control device according to claim 1.

4. A machine tool that is controlled by the control device according to claim 2.

5. A displaying method employed for a control device including a display, the displaying method comprising:
executing a code creating step that creates an optical code of information used when a failure occurs in the control device; and
executing a display controlling step that displays the optical code on the display.
